(19) United States
(12) Patent Application Publication
(10) Pub. No.: US 2009/0013599 A1
(43) Pub. Date: Jan. 15, 2009

(54) Water retention mixture and method for spray application

(76) Inventor: Peter Cordani, Palm Beach Gardens, FL (US)

Correspondence Address: MCHALE & SLAVIN, P.A., 2855 PGA BLVD, PALM BEACH GARDENS, FL, 33410, US

(21) Appl. No.: 11/775,512

(22) Filed: Jul. 10, 2007

(51) Int. Cl. C09K 17/02; A01C 15/00

(52) U.S. Cl. 47/58.1 SC; 239/661

(57) ABSTRACT

A mixture and method for applying a soil conditioner for increasing water and nutrient retention in landscaping, turf management, forestry, horticulture and agriculture. Unique to this invention is the ability to premix a super absorbent polymer with water and apply the water and polymer solution to the soil through a conventional spray applicator.

### FIELD OF THE INVENTION

The following invention relates generally to an improved method for applying a soil conditioner for water and nutrient retention in golf course landscaping and, more particularly, the invention relates to a method for applying a super absorbent polymer through a liquid sprayer. An apparatus, composition and method are disclosed for applying a super absorbent polymer as a top dressing using spray rigs or backpack sprayers.

### BACKGROUND OF THE INVENTION

Water absorbent polymers are known to improve the viability and appearance of landscaping and agricultural products in general through improved water management. These super absorbent polymers can absorb and store many times their own weight in water, forming a hydro-gel. They will extend the time between watering, serving as reservoirs of water adjacent the vegetation. The stored water is subsequently extracted from the gel and absorbed by the plant material. Properly applied, the super absorbent polymer will reduce the amount of water lost through percolation, evaporation and runoff and thereby reduce the leaching of soil nutrients, pesticides and herbicides.

Super absorbent polymers have been widely used as a way to improve plant transfer, sprig establishment and seed germination. In this use, the super absorbent polymer is applied directly to the plant roots because they are readily accessible. In addition, the super absorbent polymer can be mixed with into the soil when planting new material in the garden.

Over the years there has been a long felt need to apply super absorbent polymers for established turf management. In these situations it is not practical to remove the vegetation and treat the plant roots or the soil surrounding them. The economic benefits of large scale in ground treatment far and way exceed the impracticality of treating each plant separately. Many attempts have been made to achieve a practical and effective in situ solution. The application of the necessary amount of super absorbent polymer in the soil in an easy, uniform and homogeneous fashion has been difficult.

Mixing of a conventional super absorbent polymer with water before distribution has been attempted, however, the result is a slurry that jams the distribution pumps. If the polymer is of the gel type, the slurry will clog the pump intake resulting in pump cavation and early destruction. Even if the pump is able to distribute the slurry, the spray nozzles may clog.

### DESCRIPTION OF THE PRIOR ART

The prior art has attempted various solutions to this problem such as tilling machines, vibratory plows, seed drills, water-jet injectors and coring machines. However, each of these proposed solutions have not been shown to be satisfactory. In most instances the treatment is required prior to planting otherwise the equipment may damage the plant. These prior art devices fail to disperse the super absorbent material evenly throughout the planting area often resulting in strips of material application, holes and or grooves in the treated area. U.S. Pat. No. 5,659,998 issued to Salestrom discloses a device and process of injecting a blend of water-absorbent polymers, using one or more blow blade applicators. A further aspect of the invention includes the method of drawing the blade through the soil at an appropriate shallow angle and speed to establish a wave in the soil, together with the use of a deflector and control over the air pressure, all of which maximizes diffusion and distribution of the injected particles. U.S. Pat. No. 5,649,495, also issued to Salestrom, discloses applying a mixture to the surface and then within one to four days blending the mixture into the top four to six inches of soil using a rotary harrow or a mulcher. The seeds are then planted thereafter. U.S. Pat. No. 5,394,812, issued to Dunning et al, discloses a device that introduces the polymer below the surface by first mixing the polymer with water and then injecting the polymer and water mixture through the soil. The pump receives the mixture and delivers it through a high pressure hose to an outlet distribution device formed from a plurality of nozzles supported on a wheeled carriage frame. The mixture is injected into the soil by periodic pulsing of a solenoid type valve so that upon opening of the valve, the mixture in injected under high pressure into the soil.

The drawbacks of the prior art technologies makes the application of super absorbent polymers to soils for water retention, a complex problem which is in need of a simplified solution.

### SUMMARY OF THE INVENTION

The present invention is directed to an effective and easy to use method for applying a super absorbent polymer for water and nutrient retention in golf course landscaping and turf management. Unique to this invention is the ability to premix the super absorbent polymer with water and apply the water and polymer solution to the soil through a conventional spray applicator. Prior attempts to achieve such an elegant solution have resulted in failure, as the polymer and water solution becomes a gel and too thick to pump, thereby resulting in clogged spray devices and pumps that burn up. While super absorbent polymers have been used as soil conditioners those are typically tilled, injected or mixed into the soil. Unique to this application is the ability to spray the material over established lawns, fairways, greens, and the like landscaping without tilling the soil or disturbing the vegetation. The surface laden material provides water retention from any source including rain, sprinklers and dew.

Accordingly, it is an objective of the instant invention to provide a method that has anti-caking characteristics that allow it to be dispersed on golf courses, various turfs and agricultural products using spray rigs or backpack sprayers resulting in reduced labor and maintenance costs.

It is a further objective of the instant invention to provide a method for dispersing a super absorbent polymer that is compatible with all types of grasses and soil structures including the rough, fairways and greens.

It is yet another objective of the instant invention to provide a method that gives lasting hydration for stressed, dry and poorly irrigated areas; bunker faces, landscape beds, common areas and can be used with time release fertilizers to maximize plant and turf growing.

It is a still further objective of the invention to provide a method of providing top dressing on already established turf that gets down under the thatch layer and helps to supply plants and turf with water and nutrients where they need it the most, at the roots.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a pictorial representation of an exemplary vehicular turf sprayer that can bee used to perform the invention.

FIG. 2 is a pictorial representation of an exemplary back pack type sprayer that can be used to perform the invention.

### DETAILED DESCRIPTION OF THE INVENTION

The super absorbent polymer of the instant invention is a specially formulated fine particle powder blend that has a specific balance between gel blocking and swell-ability which can perform in demanding environments. Preferably employed are polymers that are cross linked or crosslink able homopolymers or copolymers with water binding groups (for example CABLOC®, part number XXMAPF having a particle size of between 10-50 microns. This particular super absorbent polymer compound was developed for the fiber optic cable industry. In the event of water ingress into a cable manufactured with swellable components the CABLOC® super absorbent polymers immediately swell to many times their original dry particle size. Due to the rapid swelling of CABLOC® polymers, voids within the cable are sealed immediately, preventing water movement, keeping the potential damage localized. What has been discovered and is unique to the application of this compound in solution with water is the ability to distribute the mixture through a liquid sprayer; where others result in too thick a liquid which burn up the sprayer pumps. The polymer does not gel in similar manner to super polymers thus eliminating the clogging of spray nozzles and pump intakes. It has been found that this polymer can be mixed at a rate of between 2 and 10 pounds per 100 gallons of water which would be sufficient to cover one acre of vegetation such as fairways and putting greens.

The super absorbent polymer and water solution may also include time released fertilizer, herbicide and pesticide materials. Once sprayed upon the ground, the material will seep down under the thatch layer and help to supply the plants and turf with water and nutrients where they need it the most, at the roots.

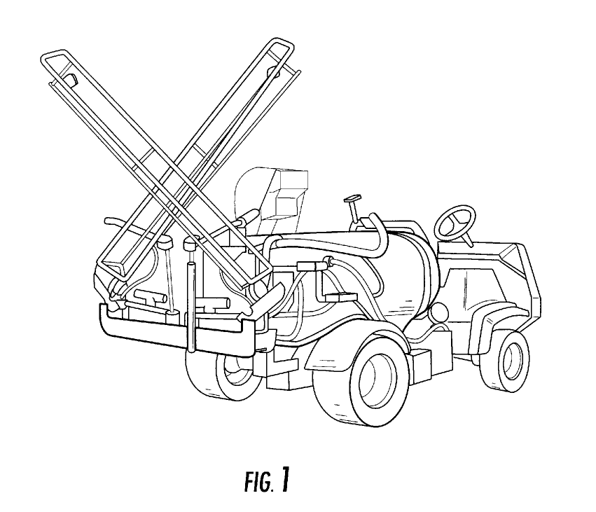

FIG. 1 is a pictorial representation of a spray application vehicle that could be used to practice of the invention. The vehicle shown is a Toro Multi Pro® 1200 and 1250 turf sprayers. They are dedicated spray application vehicles equipped with a positive displacement diaphragm pump tied directly and proportionally to the speed of the vehicle. As a result, pump flow is automatically adjusted as vehicle speed changes, which allows the application rate to remain constant over a wide speed range. This vehicle sprayer is shown by way of example only and it should be recognized that other vehicle sprayers would also be suitable.

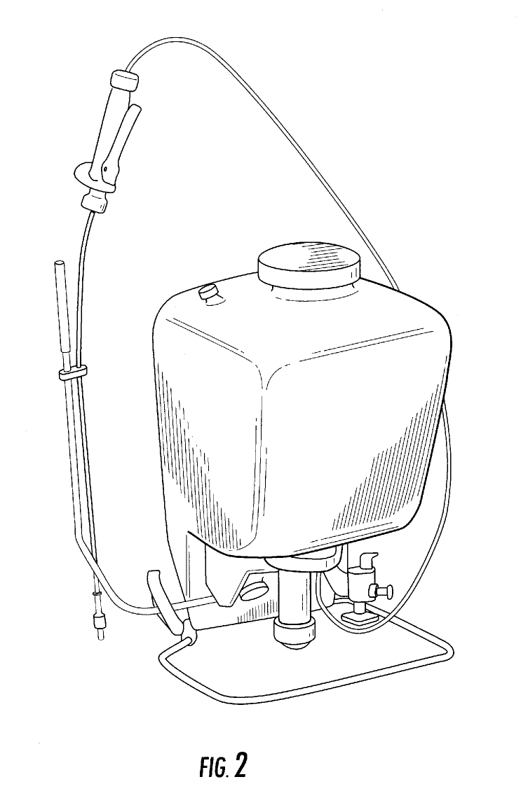

FIG. 2 is a pictorial representation of a back pack type sprayer that could be used with this invention. The backpack sprayer shown in a LESCO® ^{Polypropylene} Backpack Sprayer. The sprayer (model 051660) features a piston pump that provides working pressures up to 90 psi and includes an adjustable pressure relief valve. The backpack sprayer includes a four gallon tank and also includes a nylon shoulder harness. The diaphragm pump generates lower pressure resulting I larger droplets with less spray drift but thorough coverage. The diaphragm pump (in model 061960) is preferable for use with wettable powders whose abrasive nature may cause wear to piston pumps. This back pack sprayer is shown by way of example only and it should be recognized that other back pack sprayers would also be suitable.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of conditioning soil comprising the steps of:
obtaining super absorbent polyacrylate granules;
admixing between 2 and 10 pounds of said super absorbent polyacrylate granules with approximately 100 gallons of water to form a mixture;
distributing said mixture through sprayer means for treating up to a one acre area;
wherein said granules have a size that does not clog the sprayer means when in solution with the water whereby said mixture allows precision distribution for purposes of water retention to supplement soil moisture

2. The method of conditioning soil according to claim 1 wherein said super absorbent polyacrylate granules are less than 50 microns.

3. The method of conditioning soil according to claim 1 wherein step of distributing is performed in combination with a positive displacement diaphragm pump.

4. The method of conditioning soil according to claim 3 wherein said positive displacement diaphragm pump is operated in proportion to the speed of a distribution vehicle.

5. The method of conditioning soil according to claim 1 wherein step of distributing is performed in combination with a Toro Multi Pro® 1200 or 1250 turf sprayer.

6. The method of conditioning soil according to claim 1 wherein step of distributing is performed in combination with a portable, backpack mounted, diaphragm pump.

7. The method of conditioning soil according to claim 1 wherein said super absorbent polyacrylate granules is sold under the mark CARLOC® part number XXMAPF.
